(19) United States
(12) Patent Application Publication
(10) Pub. No.: US 2014/0181304 A1
(43) Pub. Date: Jun. 26, 2014

(54) SOCIAL NETWORK SYSTEM AND AUTHENTICATION METHOD

(71) Applicant: whosaroundme Limited, Wolverhampton (GB)

(72) Inventors: Harry Jawanda, London (GB); Brian Dass, Hoboken, NJ (US)

(73) Assignee: whosaroundme Limited, Wolverhampton (GB)

(21) Appl. No.: 14/076,297

(22) Filed: Nov. 11, 2013

(30) Foreign Application Priority Data
Dec. 21, 2012 (GB) 1223235.1

(51) Int. Cl. H04L 29/06

(52) U.S. Cl. CPC H04L 63/107
USPC 709/225

(57) ABSTRACT

The disclosure provides a social network system comprising a host server that is configured to store a plurality of user profiles and associated profile pages of users of the social network system, and to provide a plurality of private social networks to the users of the social network system. Each private social network is private to a respective geographic location, and each user profile comprises a location indicator for specifying a current location of the corresponding user. The host server comprises an access controller configured to restrict access to each private social network to users whose user profile location indicator specifies they are currently visiting the geographic location of the private social network. Also an authentication method for the social network system is disclosed.

### PRIORITY

This application claims priority of patent application number 1223235.1 filed in United Kingdom on Dec. 21, 2012. The priority application is incorporated herein by reference in its entirety.

### FIELD OF THE INVENTION

The present invention relates to a social network system, and an authentication method for the social network system.

### BACKGROUND OF THE INVENTION

Social networks are commonly used to communicate information between users participating in the social network, and can enable content added by one user to be immediately available to all the other users.

Social networks often implement features to help users filter down to only the information which is relevant to them. For example, dedicated groups may be provided for people that are interested in specific activities. Groups may also specify various authentication methods for people wishing to join them.

However, often users may not be aware of the groups that may be of interest to them, and/or authentication requirements may present an unwanted barrier to people legitimately wanting to join a particular group. Security of information is also a concern, and unscrupulous users may attempt to gain access to groups to which they are not entitled in order to gain illicit access to information.

Additionally, users may only be interested in particular groups at particular times, and selecting only the information which a user is interested in from the vast amount information that may be available can be problematic. There is a desire to provide a more accurate way of presenting information from social networks to users.

Social networks are also commonly used to advertise products and services to the people participating in the social network, and the products and services which are chosen for advertisement may for example be based upon the web pages that the user has previously visited.

However, the use of a user's past history to determine what products or services the user may be interested in purchasing today can be ineffective, as a user's past purchases may not always be a good indicator of the products or services that they may wish to purchase in the future.

It is therefore an aim of the invention to provide an improved social network system and authentication method.

### SUMMARY OF THE INVENTION

According to a first aspect of the invention, there is provided a social network system comprising a host server that is configured to store a plurality of user profiles and associated profile pages of users of the social network system, and to provide a plurality of private social networks to the users of the social network system. Each private social network is private to a respective geographic location, and each user profile comprises a location indicator for specifying a current location of the corresponding user. The host server comprises an access controller configured to restrict access to each private social network to users whose user profile location indicator specifies they are currently visiting the geographic location of the private social network.

The social network system preferably provides user profiles that are universal to all the private social networks, so that a user does not require a different user profile for each individual private social network. A particular user's user profile may be enabled for use on a particular private social network, if the access controller determines that the particular user is present at the geographic location of the particular private social network. In this respect, the social network system could be considered as a social bridging network that allows users to bridge between different private social networks whilst maintaining the same user profile.

The location indicator is used to record a location where the user is currently believed to be. If there are no estimates available on where the user is currently likely to be, then the location indicator may just be set as null or blank, preventing the user from gaining full access to any of the private social networks. The user may then simply have access to their user profile page, without having full access to one of the private social networks.

Each private social network may be private to a respective geographically located facility, and the access controller may be configured to restrict access to each private social network to users who's user profile location indicator specifies they are currently visiting the geographically located facility of the private social network. The location indicator may therefore be a visitation indicator that indicates whether the user is visiting the geographically located facility.

Advantageously, selected ones of the private social networks may be grouped together in a cluster. Then, certain types of information may be exchanged between the private social networks of the cluster according to rules that are determined by administrator(s) of the cluster. Private social networks may for example be clustered together if the private social networks are based around a common theme, or if administrators of the private social networks decide to cooperate by sharing information between their private social networks.

The social network system may comprise a user device, the user device being loaded with social network software that is associated with the social network system. The social network software may be used to help authenticate the user device to the access controller of the host server, and furthermore the social network software may assist the user in navigating the private social networks.

The social network software may be configured to send the location of the user device to the access controller, so that the access controller can determine whether the user device should be allowed access to a one of the private social networks. For example, if the user device is too far away from the geographic location, then access to the private social network by the user device may be denied or restricted.

Advantageously, full access rights to the private social network may only be granted for a period of time for which a user is expected to remain at the geographic location of the private social network, so that the private social network is secure for users to use. For example, an unscrupulous person may be prevented from gaining access to a particular private social network to determine who is present at the geographic location of the particular private social network.

The social network system may further comprise a location computer associated with a one of the geographic locations, the location computer configured to send to the access controller information identifying a user and a period of time when the user is expected to be present at the one of the geographic locations. The access controller may be configured to grant the user full access rights to the private social network that is associated with the one of the geographic locations for the period of time, by setting the user's user profile location indicator to indicate that the user is present at the one of the geographic locations for the period of time. Multiple location computers may be associated with multiple ones of the geographic locations. A location computer associated with a geographic location may be at the same location as the geographic location, or at a different location, for example if the location computer handles user information for more than just one geographical location.

The social network system may further comprise an authentication terminal at a one of the geographic locations, the authentication terminal configured to grant a user full access rights to the private social network that is associated with the one of the geographic locations, by sending a message to the access controller to set the user's user profile location indicator to indicate that the user is present at the one of the geographic locations when the user presents at the authentication terminal of the social network system. Accordingly, full access rights may only be granted when the user is known to be present at the geographic location.

The authentication terminal may be configured to send an access right restriction message to the host server when the authentication terminal is informed that a user is no longer at the geographic location, the access right restriction message limiting the access rights of the user from full access rights to limited access rights.

The limited access rights may limit the content and/or features that the user is able to access within the private social network, or may even prevent the user from gaining any access to the private social network. For example, the user's account may just be maintained in a dormant state until the next time the user is at the geographic location.

At least one of the private social networks may provide limited access rights to all the users having a user profile on the social network system. The limited access rights may enable the user to discuss with staff associated with the private social network, and/or to discuss with other people who may be considering visiting the geographic location of the private social network. Accordingly, the user may have limited access rights to prior to booking their first visit to the geographic location, or prior to making their first visit to the geographic location.

The limited access rights available to users prior to booking or visiting a geographic location for the first time, may differ from the limited access rights available to users who have already visited the geographic location. For example, only users who have previously visited the geographic location may be provided with the right to post feedback on products or services available at the geographic location.

Multiple ones of these authentication terminals may be associated with respective multiple ones of the geographic locations. One or more of these geographic locations may be associated with locations computer(s).

The geographic location may for example be the geographic location of a hotel, and the authentication terminals may be located at check-in desks of the hotel. The user may be considered to be at the geographic location for as long as the user is staying at the hotel, for example the user may be granted full access rights when checking into the hotel, and may have their access rights restricted or terminated when checking out of the hotel. The location computer may be a hotel computer that is managed by the hotel and stores information on which users are booked into the hotel.

Each user profile may comprise personal information about the user, for example, a photograph of the user, and optionally a status message last posted by the user and any recent activity of the user on the social network system. The user profile may comprise a validation field recording whether or not the user of the user profile has been validated as being genuine, for example whether or not the user has used their credit or debit card to book products/services at a one of the geographic locations, whether the user has been personally met by a person operating a location computer, or by a person operating an authentication terminal. The user profile may record how the user was validated, for any subsequent checks that are carried out. Full access rights to a private social network may only be granted if the user profile indicates that the user has been validated, to help prevent the use of fake profiles which could compromise security.

The user's profile page may be based on a template that is the same for all users, and which is populated with information based upon the user's profile when the user wishes to view their profile page.

Advantageously, the host server may further comprise a publishing controller configured to publish information to the profile pages, the published information that is published to each profile page being filtered according to the user profile associated with the profile page. The user profile may for example contain information on social activities or groups that the user is interested in, as will be apparent to those skilled in the art.

The published information may comprise information on events taking place at a one of the geographic locations indicated by the user profile associated with the profile page, and/or information on any offers that may be available. Accordingly, the published information may be targeted towards the products and services that are available at geographic locations that the user is interested in, which may be much more relevant than information purely based upon previous browsing history. The geographic locations indicated by the user profile may be the geographic locations that the location indicator has previously been set to, is currently set to, or is scheduled to be set to in the future.

The published information on a one of the private social networks may comprise information on external events that are scheduled to take place outside of the geographic location of the one of the private social networks.

The published information may be applied to each one of a cluster of private social networks, the cluster of private social networks being grouped together by virtue of the geographical locations of the private social networks sharing a common theme, or by virtue of administrators of the private social networks deciding to cooperate with one another by clustering their private social networks so that information can be shared between the private social networks.

For example, five private social networks at five respective geographic locations, each geographic location having a hotel of the same hotel chain, may be clustered together in a group. The group of five private social networks of the same hotel chain may have an item of published information applied to it, such that the item of published information appears in all of the private social networks of the group. For example, the item of published information may be a particular offer that is common to the hotel chain. As another example, a pet shop and a veterinary surgery may decide to cluster the private social networks at their geographic locations into a group, to help increase both their customer bases by collaborating on marketing material to be posted on both the grouped private social networks.

The user profile of a user having full access rights may be intermittently updated with a sub-location of the user, the sub-location of the user being sent to the host server from a user device of the user. The user is assumed to be at the same location as their user device, which will generally be true when the user is browsing the social network system on their user device.

The sub-location of the user is a more accurately specified location of the user than the geographic location, and may specify the position of the user at the geographic location. The sub-location of the user may be used to help filter the published information that is sent to the user, for example if the geographic location is a hotel and the sub-location of the user is determined to be the hotel bar, then the user may be presented with drinks offers.

The sub-location of the user may be sent to the host server from the social network software that is associated with the social network system, the social network software being executed on the user device.

New users may be allowed to create a user profile in the social network system by importing their username and password from an external social network site. Further information, for example a photograph, may also be imported into the social network system from the external social network, in order to build the user's user profile on the social network system. Subsequently, the user may log into the social network system using the same username and password as for the external social network. Alternatively, a new user may create a user profile in the social network system directly, without going via an external social network.

If one user creates two user profiles from two separate external social networks, then the two user profiles may be linked to one another, and the validation and location indicators of each of the two user profiles may be synchronised with one another or combined. The linking may take place manually, for example if the user explicitly requests linking or two or more accounts during the validation of the user, or the linking may take place automatically, for example if the social network system recognises that the information stored in two separate user accounts suggests that the user accounts belong to the same user.

The social network system may be configured to allow each user to create connections to other users, for example so that the user can view conversations specific to particular groups of users that are connected to one another. Each user profile may comprise a list of users to which the user of the user profile has a connection. Each connection may be constituted by a line in a first user's user profile, the line specifying a second user's user profile. The connection indicates that information on the first user may be sent to the second user.

The connections that a user creates may be used to pass information between connected users via the social network system. For example, information may originate from the user's profile on an external social network, and be sent via the social network system to other users with which the user has a connection, for the other users to view using other external social networks. Therefore the social network system may operate to form a bridge between different external social networks by way of the connections.

Advantageously, visual representations of users that currently have full access rights to a private social network and which are within the list of users that a user has connection to, may be displayed to the user when the user accesses the private social network.

Visual representations of users that do not currently have full access rights to the private social network may not be displayed to the user, even if the user has a connection with them. Or, the visual representations of the users may be displayed, but indicate that the users are not present at the geographic location. Accordingly, a user may be informed of which users to which the user has a connection are currently at the geographic location.

The host server may be configured to accept invisibility requests from user devices, so that a particular user can appear invisible to other users on a one of the private social networks, for example if the user does not wish for other users to be aware that the user is present at the geographic location of the one of the private social networks. The host server may be configured to assign the invisibility request to the user's profile so that visual representations of the user on the private social network are either not displayed to other users of the private social network, or indicate that the user is not present at the geographic location of the private social network. The invisibility request may specify a particular private social network to which the invisibility request is to be applied, or the private social network to which the invisibility request is to be applied may be automatically determined as the private social network(s) to which the user currently has full access rights.

Advantageously, host server may be configured to provide a feedback interface for users to post feedback on services that are available at the geographic locations. The feedback interface may be configured to only accept feedback relating to services at the geographic locations that the location indicator of the user's user profile indicates the user has previously or is currently visiting. This may help prevent the posting of fake feedback by users wishing to illegitimately influence a product or services feedback ratings, and allow providers of products or services at the geographic location to more accurately assess, and respond to, the feedback that is provided. Accordingly the users experience of the products or services, and the reputation of the products or services, can be more effectively managed. Since feedback may be provided whilst the user is still at the geographic location, negative feedback may be immediately addressed to improve the user's experience whilst still at the geographic location, and possibly revised by the user as a result.

The feedback interface may allow exporting of the feedback that is received to external sites. The feedback interface may allow a user to provide feedback in the form of a video recording of themselves, as well as allowing textual feedback.

The host server may be located at one of the geographic locations, or elsewhere. The host server is preferably accessible to user devices via the Internet.

To help assure that users are always able to access a one of the private social networks when they are at the geographic location associated with the one of the private social networks, data at the host server that is relevant to the one of the private social networks may be mirrored by a local server at the geographic location associated with the private social network. The local server may be accessible to user devices via a local area wireless network, in case of failure of user devices to connect to the host server. The data that is mirrored typically comprises the user profiles of users currently visiting or scheduled to visit the geographic location of the one of the private social networks, and content information relevant to the private social network. The local server may also be accessible to user devices via other data providers that enable Internet access at the geographic location, for example via a 3G mobile phone network operator.

The social network system may further comprise a content computer at the geographic location, the content computer configured with content creation software for creating content and loading the content into the content database. Accordingly, a person at a one of the geographic locations may determine what content should be available on the private social network of the geographic location. If the host server is located in the cloud, i.e. is at a different location to the computer and is accessible via the Internet, then loading the content into the content database may comprise uploading the content over the Internet from the content computer to the host server. The content computer may be the same computer as the aforementioned location computer.

The social network system may enable the creation of employee accounts which provide access to a specific one(s) of the private social networks, and are designed for employees providing services at the geographic locations of the private social networks to respond to comments posted on the private social networks from users of the services.

The social network system may also provide an administrator account for each private social network, the administrator account being usable by a provider of services that are available at the geographic location to edit the content available on the private social network.

According to a second aspect of the invention, there is provided an authentication method for a social network system, wherein the social network system comprises a host server that is configured to store a plurality of user profiles and associated profile pages of users of the social network system, and to provide a plurality of private social networks to the users of the social network system. Each private social network is private to a respective geographic location, and the host server comprises an access controller configured to control access to the private social networks. The authentication method comprises:

creating a user profile for a user and assigning a username and password to the user profile, the user profile comprising a location indicator for specifying a current location of the user;

receiving a request for access to a one of the private social networks at the access controller, from a user device supplying the username and password;

identifying the user profile from the username and password; and

granting the user device full access rights to the one of the private social networks if the location indicator of the user profile indicates the user is at the geographic location of the one of the private social networks.

The authentication method may be executed upon the system of any of the appended claims 1 to 21.

The authentication method may comprise reviewing bookings for the geographic locations, and setting the location indicator of each user profile to correspond to a geographic location for time periods when the corresponding user is booked to be at the geographic location.

If one of the geographic locations is a hotel, then the value of the location indicator may be set to correspond to the geographic location of the hotel by a hotel receptionist serving the user at the hotel check-in desks.

The granting the user device full access rights to the one of the private social networks may further be contingent upon the user profile indicating that the user associated with the user profile has been validated as being a genuine user, to help improve security.

### SHORT DESCRIPTION OF THE DRAWINGS

FIG. 1 shows a schematic block diagram of a social network system according to an embodiment of the invention; and

FIG. 2 shows a flow diagram of an authentication method according to an embodiment of the invention.

### DETAILED DESCRIPTION OF THE INVENTION

Embodiments of the invention will now be described with reference to the accompanying drawings, in which:

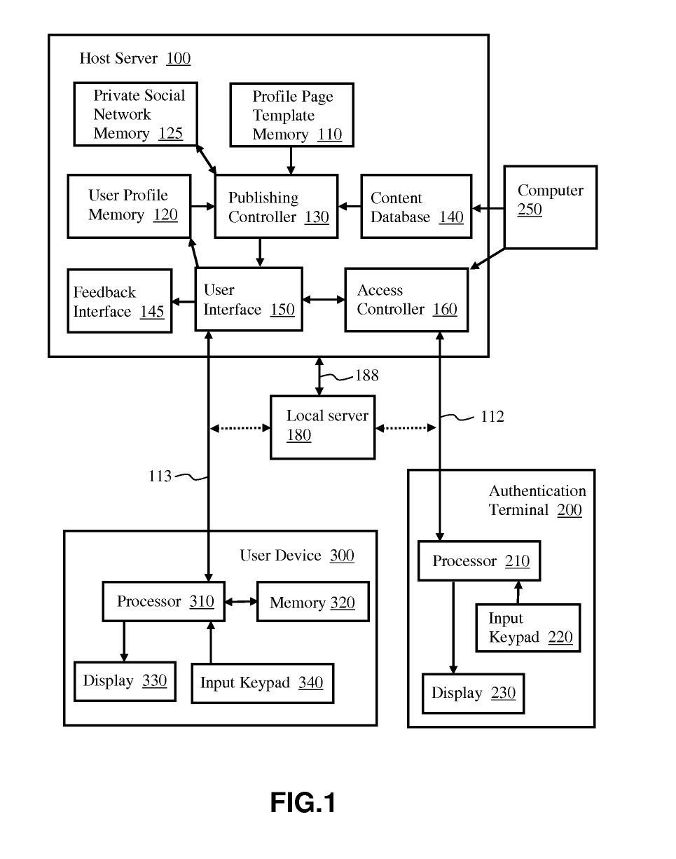

The schematic diagram of FIG. 1 shows a social network system comprising a host server 100, a local server 180, an authentication terminal 200, a computer 250, and a user device 300. The host server 100 and authentication terminal 200 are able to communicate with one another via an Internet connection 112, and the host server 100 and user device 300 are able to communicate with one another via an Internet connection 113.

The host server 100 is a cloud-based system accessible via the Internet, and maintains a plurality of private social networks for respective geographic locations. In this embodiment, each respective geographic location corresponds to a hotel.

The host server comprises user profiles in a memory 120, a profile page template in a memory 110, and a collection of content within a content database 140. The host server 100 further comprises a plurality of private social networks that are stored within a memory 125. Within memory 125, each private social network has information such as the users that have previously joined the private social network, conversation histories between the users, and information defining groups of users pertaining to the private social network.

The host server also comprises a publishing controller 130 that is connected to the memories 110, 120, and 125, and that populates the profile page template with information from a user profile, a one of the private social networks, and the content database 140. The information from the content database 150 that is populated into the profile page template may be filtered (chosen) according to user preference information that is stored in the user profile.

The host server 100 also comprises a user interface 150 through which a user may send information concerning their user profile, and receive a view of the populated profile page from the publishing controller 130. The host server 100 further comprises an access controller for controlling the access provided by the user interface 150 to the user profile and populated profile page.

The user interface 150 is connected to a feedback interface 145 which a user may use to provide feedback on goods and services that the user has received at a one of the hotels.

The access controller 160 controls access to the social network system, and is used to help maintain usernames and passwords associated with the user profiles, and location identifiers associated with the user profiles.

The local server 180 is located at a first one of the hotels, and mirrors the private social network for the first hotel via an Internet connection 188. The local server 180 provides a local area wireless network by which the user device 300 and authentication terminal 200 can access the local server 180, to take over or temporarily replace the connections 112 and 113. Accordingly, the local server 180 helps ensure that users are always able to gain access to the private social network for the first hotel, even if the Internet connections 112 and/or 113 temporarily fail.

The computer 250 is located at the first hotel, and constitutes both a content computer and a location computer. In particular, the computer 250 is configured with content creation software for creating content and loading the content into the content database 140 via the Internet. Accordingly, the hotel can use the computer 250 to define the content that should appear to users that visit the first hotel. Furthermore, the computer 250 stores details upon the guests of the first hotel, in particular the periods of time for which various guests are booked to be at the first hotel. The computer 250 is configured to send these details to the access controller 160, for matching of these details to user profiles of the guests, so that the user profiles can be granted full access rights on the private social network that corresponds to the first hotel for the periods when the guests are booked in at the first hotel.

The authentication terminal 200 is installed at the check-in desk of the first hotel, and has an input keypad 220 and display 230. The input keypad 220 and display 230 are intended for use by the check-in desk receptionist when checking a user into the first hotel. The authentication terminal 200 also comprises a processor 210, which may access the access controller 160 of the host server 100 over the Internet, for example in order to provide a user who is checking into the first hotel with full access rights to the private social network of the first hotel. Clearly, more than one authentication terminal 200 may be provided, for example if multiple check-in desks are present.

Although only one computer 250, one local server 180, and one authentication terminal 200 are shown in FIG. 1 for clarity, the full social network system of this embodiment comprises at least one computer 250, at least one local server 180, and at least one authentication server 200, for every one of the hotels.

The user device 300 is a device that belongs to the user, such as a smartphone, and which comprises a processor 310, a memory 320, a display 330, and an input keypad 340. The processor 310 is configured to connect to the Internet, so that it can access the user interface 150 of the host server 100. The memory 320 may be loaded with social network software, which may be run on the processor 310 to provide enhanced access to the user interface 150. A view of the user interface 150 may be displayed on the display 330 for the user to view.

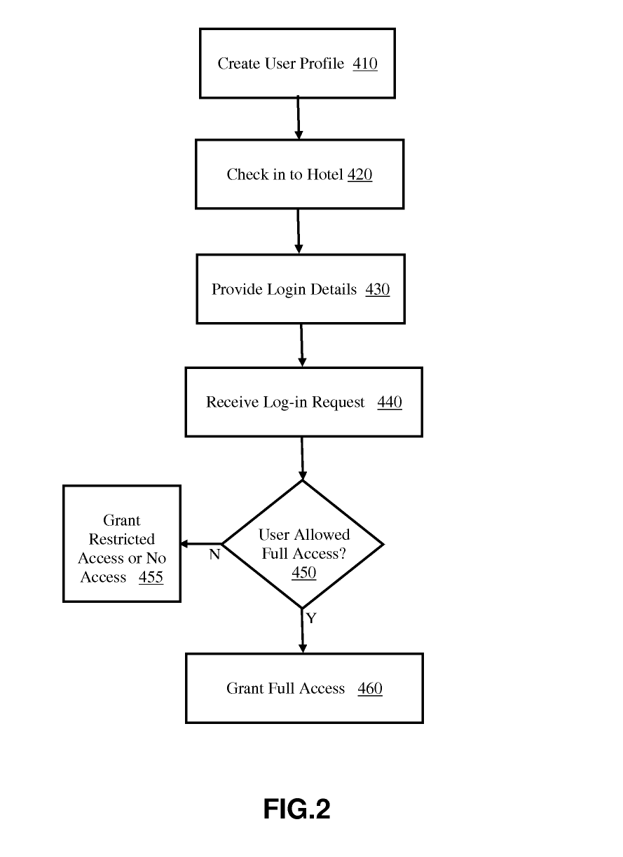

The authentication of the user device 300 for use on the social network system of FIG. 1 will now be described with reference to the flow diagram of FIG. 2. In a first step 410, a user creates a user profile by navigating to the user interface 150 on the display 330 via the Internet, and logging into the host server using the username and password of an external social network. The user profile is created with the user's name and email address, a validation field having a value of FALSE to indicate that the user has yet to be validated, and a location indicator having a value of NULL to indicate that the location of the user is unknown.

The user then books into the first one of the hotels, for example for the first weekend in July. During booking the user provides their name and email address to the first hotel, and pays a deposit via a credit or debit card, validating that the user is genuine. The booking information is entered into the computer 250, and is subsequently sent from the computer 250 to the access controller 160. The access controller 160 identifies the user profile in the user profile memory 120 based upon the supplied name and email address, changes the value of the validation field in the user profile to TRUE, and changes the location indicator to indicate that the user will be at the first hotel from Friday evening to midday Sunday on the first weekend in July.

When the user next logs into the social network system using their device 300, but before their stay at the first hotel, the publishing controller 130 recognises from the location indicator in the user profile that the user will soon be staying in the first hotel, and so populates the user's profile page with information from the content database 140 that is relevant to the first hotel. Accordingly, the screen 330 displays offers that are available at the first hotel on the user's profile page. Since the location indicator does not indicate that the user is currently staying at the hotel, the user does not get full access rights to the private social network of the first hotel on this occasion.

Alternatively, the user may be required to send a request for the validation field and/or location indicator of their user profile to be updated after the user has booked into a hotel. For example, the user may select the hotel into which they have booked from a list of hotels when the user logs into the social network system. The selected hotel may be contacted by the social network system to see if the user is genuinely booked to stay there, and therefore whether the location indicator should be updated to reflect that the user will be staying at that hotel for the booked period of time.

In a second step 420, the user arrives at the first hotel earlier than expected on Friday afternoon of the first weekend in July, and checks-in at a check-in desk having the authentication terminal 200. The check-in process comprises the check-in desk receptionist entering the user's name into the authentication terminal 200 via the input keypad 220.

The processor 210 sends the user's name and email address details to the access controller 160 of the host server 100, along with expected duration of the user's stay at the hotel, i.e. until midday Sunday. The access controller 160 identifies the user's user profile in the user profile memory 120, and amends the location indicator to specify that the user is present at the hotel from the current time until midday Sunday.

At step 430, on Friday evening, the user uses their device 300 to navigate on the Internet to the user interface 150 of the host server 100, and types in their username and password with the input keypad 340 to make a request to log into the social network system.

At step 440, the access controller 160 receives the log-in request, and then identifies the user's user profile in step 450. The access controller 160 then grants full access to the private social network of the first hotel in a step 460, since the access controller determines that the user has been validated from the validation field of the identified user profile, and that the user is currently at the geographic location of the first hotel from the location indicator of the identified user profile.

If the access controller 160 determines from the validation field, or the location indicator, that the user has not been validated, or is not at the geographic location of the first hotel, then at step 455 either limited access rights to the private social network of the first hotel may be granted, or no access rights to the private social network of the first hotel may be granted at all.

The grant of full access to the private social network of the first hotel results in the user interface 150 sending for display on the device 300 a profile page template that is populated with the user's details, information from the private social network, and information from the content database 140. The user may then interact on the private social network with other users of the private social network that are at the first hotel using their device 300. The user may add information to their user profile, by uploading photographs, information on their hobbies or interests, or status updates.

The first hotel periodically adds information to the content database 140 using the computer 250, together with criteria for which users should receive the content, so that the publishing controller 130 can select which content is appropriate for display to which users. For example a user which lists football as a hobby in their user profile may be informed of sports events that are happening at the hotel, or a user who lists dining out as a hobby may be informed of offers available in the hotel restaurant.

Each user profile comprises a list of users to which the user of the user profile has connected, and the users which are currently logged into the private social network, i.e. which are present at the hotel, and which are listed as a connection, may be displayed to the user. The user interface 150 allows the user to send an invisibility request from their user device 300, so that they will appear invisible to other users of the private social network. Additional features which are common to known social networks, for example defining groups or events which people can “join” on the private social network, may also be implemented.

The user interface 150 may allow the user of the user device 300 to view selected ones of multiple profile page templates on the display 330, each profile page template being tailored by the publishing controller 130 according to the user's user profile stored in memory 120. For example, the user interface 150 may allow the user to view a feedback page from the feedback interface 145, the feedback page being populated with products and services upon which the user may give feedback. The publishing controller 130 may filter the products and services upon which the user can give feedback based upon the user profile, for example if the user profile indicates that the user has used a particular product or service.

The user may consent to their use of various amenities or purchase of products/services services within the hotel being automatically uploaded to their user profile, for the purposes of providing feedback later. For example, if the user orders fish and chips in the hotel restaurant, then the purchasing terminal used to settle the user's bill may upload to the host server 100 the fact that the user had fish and chips to the user profile of the user. Then, when the user subsequently logs into the social network using their user device 300, they may be presented with a request to rate the quality of the fish and chips, possibly in return for receiving a discount for next time that they visit the restaurant.

Once the user comes to check-out of the hotel on Sunday morning, the authentication terminal 200 at the check-in desks may send an access right restriction message to the host server 100, informing the access controller 160 that the user is no longer staying at the first hotel. The access controller sets the location indicator in the user profile to indicate the user is not longer at the first hotel, and the user can no longer fully access the private social network of the hotel. Accordingly, the content that user is able to see via the user interface 150 may be significantly reduced, for example it may no longer be possible to view conversational threads between people that are currently staying at the first hotel, although the feedback interface 145 may still be accessible for providing feedback on the products/services received at the hotel.

If the user does not visit the check-in desks when they leave the hotel, then the location indicator will not be altered, and so the user will continue to have access to the private social network until midday on Sunday.

Although the specific embodiment has been discussed in relation to a private social network of a hotel, the scope of the appended claims also encompass private social networks for other types of facility which are at a particular geographical location, for example airports, museums, apartment buildings, cruise ships, etc, as will be apparent to those skilled in the art.

Further alternate embodiments falling within the scope of the appended claims will also be apparent to the skilled person.

What is claimed is:

1. A social network system comprising a host server that is configured to store a plurality of user profiles and associated profile pages of users of the social network system, and to provide a plurality of private social networks to the users of the social network system, wherein each private social network is private to a respective geographic location, and wherein each user profile comprises a location indicator for specifying a current location of the corresponding user, the host server comprising an access controller configured to restrict access to each private social network to users whose user profile location indicator specifies they are currently visiting the geographic location of the private social network.

2. The social network system of claim 1, further comprising a user device, the user device being loaded with social network software that is associated with the social network system.

3. The social network system of claim 1, further comprising a location computer associated with a one of the geographic locations, the location computer configured to send to the access controller information identifying a user and a period of time when the user is expected to be present at the one of the geographic locations, and wherein the access controller is configured to grant the user full access rights to the private social network that is associated with the one of the geographic locations for the period of time, by setting the user's user profile location indicator to indicate that the user is present at the one of the geographic locations for the period of time.

4. The social network system of claim 1, further comprising an authentication terminal at a one of the geographic locations, the authentication terminal configured to grant a user full access rights to the private social network that is associated with the one of the geographic locations, by setting the user's user profile location indicator to indicate that the user is present at the one of the geographic locations when the user presents at the authentication terminal of the social network system.

5. The social network system of claim 4, wherein the authentication terminal is configured to send an access right restriction message to the host server when the authentication terminal is informed that a user is no longer at the one of the geographic locations, the access right restriction message limiting the access rights of the user from full access rights to limited access rights.

6. The social network system of claim 5, wherein the limited access rights limit the content that the user is able to access within the private social network.

7. The social network system of claim 4, wherein the grant of a user full access rights to the private social network when the user presents at the one of the geographic locations of the social network system, comprises granting the full access rights for a length of time for which the user is expected to remain at the one of the geographic locations.

8. The social network system of claim 4, wherein the one of the geographic locations is the geographic location of a hotel, and wherein the authentication terminal is located at a check-in desk of the hotel.

9. The social network system of claim 1, wherein the host server further comprises a publishing controller configured to publish information to the profile pages, the published information that is published to each profile page being filtered according to the user profile associated with the profile page.

10. The social network system of claim 9, wherein the published information comprises information of events taking place or offers available at one of the geographic locations indicated by the user profile associated with the profile page.

11. The social network system of claim 2, wherein the user profile of a user having full access rights is intermittently updated with a sub-location of the user, the sub-location of the user being sent to the host server from the user device.

12. The social network system of claim 9, wherein the filtering of the published content is dependent upon the sub-location of the user that is sent to the host server from the user device.

13. The social network system of claim 1, wherein each user profile comprises a list of users to which the user of the user profile has connections.

14. The social network system of claim 13, wherein visual representations of users that currently have full access rights to a one of the private social networks and which are within the list of users that the user has a connection to, are displayed to the user when the user accesses the one of the private social networks.

15. The social network system of claim 2, wherein a user can send an invisibility request to the host server using the user device, the host server configured to assign the invisibility request to the user's profile so that visual representations of the user on a one of the private social networks are either not displayed to other users of the one of the private social networks, or indicate that the user is not present at the geographic location of the one of the private social networks.

16. The social network system of claim 1, wherein the host server is configured to provide a feedback interface for users to post feedback on services that are available at the geographic locations, and wherein the feedback interface is configured to only accept feedback relating to services at the geographic locations that the location indicator of the user's user profile indicates the user has previously or is currently visiting.

17. The social network system of claim 2, further comprising a local server at a one of the geographic locations, the local server configured to mirror data of the host server that is relevant to the private social network that is associated with the one of the geographic locations, the local server being accessible to user devices via a local area wireless network.

18. The social network system of claim 2, further comprising a content computer at the geographic location, the content computer configured with content creation software for creating content and loading the content into the content database.

19. The social network system of claim 1, wherein each user profile comprises a validation field, the validation field recording whether or not the user of the user profile has been validated as being genuine.

20. The social network system of claim 1, wherein each private social network is further private to a facility at the respective geographic location, and wherein the location indicator constitutes a visitation indicator for specifying whether the corresponding user is visiting the facility.

21. An authentication method for a social network system, wherein the social network system comprises a host server that is configured to store a plurality of user profiles and associated profile pages of users of the social network system, and to provide a plurality of private social networks to the users of the social network system, wherein each private social network is private to a respective geographic location, and wherein the host server comprises an access controller configured to control access to the private social networks, the authentication method comprising:
creating a user profile for a user and assigning a username and password to the user profile, the user profile comprising a location indicator for specifying a current location of the user;
receiving a request for access to a one of the private social networks at the access controller, from a user device supplying the username and password;
identifying the user profile from the username and password; and
granting the user device full access rights to the one of the private social networks if the location indicator of the user profile indicates the user is at the geographic location of the one of the private social networks.
